(19) United States
(12) Patent Application Publication
(10) Pub. No.: US 2003/0149584 A1
(43) Pub. Date: Aug. 7, 2003

(54) Method for micrositing a wind park

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/276,187

(22) PCT Filed: Mar. 31, 2001
(86) PCT No.: PCT/EP01/03706

(30) Foreign Application Priority Data
May 11, 2000 (DE) 100 22 978.6

(51) Int. Cl. G06F 17/60

(52) U.S. Cl. 705/1; 705/412

(57) ABSTRACT

The invention concerns a method of micrositing a wind park.

The object of the present invention is to avoid the previous disadvantages and problems when micrositing wind parks and to make the micrositing procedure overall simpler and less expensive.

A method of micrositing a wind park by means of a computing apparatus or computer and a wind park calculation program using surveying data in respect of the surface of the earth.

### DESCRIPTION

The invention concerns a method of micrositing a wind park.

The term micrositing is usually used to denote the placement of a wind power installation within a wind park. In that respect each individual wind power installation is to be optimally set up at the respective location having regard to the criteria such as maximum energy yield (best locations in regard to the prevailing wind distribution), necessary spacings of the installations from each other and the smallest possible expenditure in terms of infrastructure (roads, foundation structures, crane-standing areas and so forth).

For relatively large wind parks that micrositing is generally implemented by means of location maps (of the future wind park). The layout of a park is then established on the basis of that map material and a next step then involves accessing the location for inspection on foot, in which case the demands on the infrastructure are considered in detail. Depending on the respective location and the weather conditions, that is under some circumstances an arduous undertaking. In addition accessing the site on foot in that way does not give an overview of the entire wind park.

The object of the present invention is to avoid the previous disadvantages and problems when micrositing wind parks and to make the micrositing procedure overall simpler and less expensive.

In accordance with the invention that object is attained by a method having the features set forth in claim 1. Advantageous developments are set forth in the appendant claims.

The method according to the invention provides that surveying data in respect of the surface of the earth are processed in a computing apparatus or computer by means of a suitable park calculation program (for example WASP) and on the basis of those data the energy yield of an individual wind power installation within an entire park is calculated for the respective planned wind park location and in addition a value in respect of the so-called park efficiency can also be specified. That park efficiency is a measurement in respect of the average reduction in the yield of the individual installations in the park in comparison with a wind power installation at an individual location. In addition the method according to the invention means that the operation of accessing the planned wind park location on foot, which is laborious under some circumstances, can be avoided. Also, there is no longer any need for the planned wind park location also to be viewed from a helicopter so that the costs in this respect can also be eliminated.

By means of the method according to the invention, the region of the planned wind park is selected from the available data sets of the surveying data of the surface of the earth and a three-dimensional model is produced. That can be done virtually (with a display screen) but also really on the basis of a model consisting of wood, metal or other material. That model permits simple micrositing of the wind power installations, with an overview over the entire planned wind park.

The micrositing procedure according to the invention means that the micrositing method for the entire wind park can be simplified and speeded up and it is possible to arrive at a more precise option in terms of calculating the wind conditions and thus also an increase in the wind park yield results. In addition more accurate results can be achieved by means of the data sets of the surveying data in respect of the surface of the earth when using suitable park calculation programs.

The use of surveying data in respect of the surface of the earth as were obtained by the international mission of the crew of the space shuttle “Endeavour” in February 2000 is particularly advantageous. In that respect, by means of a novel procedure, NASA surveyed the entire earth and made those data sets available in electronic form, which in terms of suitable use and programming, make it possible to produce a three-dimensional image of any region or point on the surface of the earth. The particular advantage in using those data sets is also that they are already available in electronic form and accordingly can be processed in a relatively simple manner by park calculation programs.

Employment or use of the data sets in respect of three-dimensional surveying of the surface of the earth by NASA makes it possible generally for planning of the micrositing of a wind park to be markedly shortened and made considerably less expensive. In addition the park efficiency and also the wind park output can be increased.

1. A method of micrositing a wind park by means of a computing apparatus or computer and a wind park calculation program using surveying data in respect of the surface of the earth.

2. A method according to claim 1 characterised in that for the operation of micrositing a planned wind park the available data sets of the surveying data of the surface of the earth where the wind park is to be set up are selected and made into a three-dimensional model.

3. A method of increasing the power yield of a wind park and/or the wind park efficiency using the method according to one of the preceding claims in planning the wind park.
